(19) United States
(12) Patent Application Publication
(10) Pub. No.: US 2008/0095623 A1
(43) Pub. Date: Apr. 24, 2008

(54) COUNTER-ROTATING FAN

(75) Inventor: Yusuke YOSHIDA, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 11/937,616

(22) Filed: Nov. 9, 2007

Related U.S. Application Data
(63) Continuation-in-part of application No. 11/746,716, filed on May 10, 2007.

(30) Foreign Application Priority Data
May 10, 2006 (JP) 2006-131426

(51) Int. Cl. F03D 1/02

(52) U.S. Cl. 416/128

(57) ABSTRACT

A counter-rotating axial fan includes two impellers each having a plurality of blades and two motors for rotating the impellers, respectively. The impellers are rotated by the respective motors in directions opposite to each other. The impellers and the motors are surrounded by a housing which defines an air path through which a current of air generated by rotation of the impellers flows. The housing includes an expanding portion, at which an area of a cross section of the air path substantially perpendicular to the center axis is larger than that in an axially middle portion of the housing, located between the first impeller and the second impeller.

### CROSS-REFERENCE TO RELATED APPLICATIONS

This application is a Continuation-In-Part of U.S. patent application Ser. No. 11/746,716, filed on May 10, 2007, currently pending.

### BACKGROUND OF THE INVENTION

1. Field of the Invention

The present invention relates to a counter-rotating fan including coaxially arranged fans.

2. Description of the Related Art

Electronic devices such as personal computers and servers include cooling fans for cooling electronic components inside the respective electronic devices. With increases in the density of arrangement of the electronic components, the cooling fans are required to have higher cooling performance. In particular, relatively large-sized electronic devices, e.g., servers, require cooling fans which are high in both a static pressure and an airflow rate.

Moreover, for the cooling fans for use in electronic devices, improvements in sound characteristics have been also required, for example, from a viewpoint of improvement of a working environment where the electronic devices are used. One standard used for estimating the sound characteristics is a prominence ratio indicating a ratio of a prominent discrete tone in audible areas. As the prominence ratio decreases, the sound characteristics are improved.

In a case where fans are arranged in series as in a counter-rotating axial fan, for example, ribs for supporting an impeller in each fan are arranged on the same side of the impeller for design purposes or the like. This means that the ribs are arranged on both sides of one impeller, i.e., on both an air-inlet side and an air-outlet side. Thus, a change in a current of air or a pressure of air on the air-inlet side and the air-outlet side of the impeller during rotation of the impeller may interfere with the ribs so as to lower the sound characteristics, that is, make harsh noises in the audible bands louder.

In addition, serial fans, i.e., fan units each including two or more fans arranged in series such as counter-rotating axial fans, each uses two or motors, whereas usual axial fans each uses a single fan. Therefore, reduction in power consumption is a problem in the development of the serial fans.

### SUMMARY OF THE INVENTION

According to a counter-rotating axial fan of a preferred embodiment of the present invention, the first impeller, centered on and rotatable about a center axis, has a plurality of first blades. The first blades are arranged about the center axis and extend outwardly in a radial direction substantially perpendicular to the center axis. The first motor is provided for rotating the first impeller. The second impeller, centered on and rotatable about the center axis and arranged axially adjacent to the first impeller, has a plurality of second blades. The second blades are arranged about the center axis and extend outwardly in the radial direction. The second motor is provided for rotating the second impeller in a direction opposite to a direction of rotation of the first impeller. A housing surrounds the first and second impellers, thereby defining an air path therein. The housing includes an expanding portion. An area of a cross section of the air path that is substantially perpendicular to the center axis is larger in the expanding portion than at least in a substantially axially middle portion thereof. The expanding portion is located between the first impeller and the second impeller.

The housing may include a first housing member surrounding the first impeller and a second housing member surrounding the second impeller. In this case, the first and second housing members are joined to each other in the expanding portion so to define the housing.

It is preferable that an end of the first housing member, which is adjacent to the second housing member, cover an end of the second housing member, which is adjacent to the first housing portion, when the first housing member and the second housing member are viewed from above the first housing member.

It is also preferable that at a connection of the housing where the first and second housing portions are joined to each other, an angle of a tangent line of an inner side surface of one of the first and second housing members with respect to the center axis be substantially equal to that of the other.

It is preferable that the first and second housing members be approximately rectangular when viewed along the center axis. In this case, the first housing member preferably includes at four corners four first inclined surfaces which are inclined with respect to the center axis so as to move away from the center axis as they move toward the second housing member; the second housing member includes at four corners four second inclined surfaces which are inclined with respect to the center axis so as to move away from the center axis as they move toward the first housing member; and the first inclined surfaces and the second inclined surfaces together define the expanding portion of the housing.

The counter-rotating axial fan may further include: a plurality of first ribs arranged about the center axis, extending from the first motor outwardly in the radial direction, and connected to the first housing member to support the first motor; and a plurality of second ribs arranged about the center axis, extending from the second motor outwardly in the radial direction, and connected to the second housing member to support the second motor. The first ribs are arranged between the first impeller and the second impeller, while the second ribs are arranged between the first impeller and the second impeller.

The second ribs may be arranged on a side of the second impeller opposite to the first impeller.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a perspective view of a counter-rotating fan according to a first preferred embodiment of the present invention.

FIG. 2 is an exploded perspective view of the counter-rotating fan of FIG. 1.

FIG. 3 is a cross-sectional view of the counter-rotating fan of FIG. 1, taken along a plane containing a center axis of the fan.

FIG. 4 is a plan view of a first axial fan in the counter-rotating fan of FIG. 1.

FIG. 5 is a plan view of a second axial fan in the counter-rotating fan of FIG. 1.

FIG. 6 is another plan view of the first axial fan in the counter-rotating fan of FIG. 1.

FIG. 7 shows cross-sections of a first blade, a first rib, and a second rib in the first preferred embodiment of the present invention.

FIG. 8 is a plan view of a first axial fan in a counter-rotating fan according to a second preferred embodiment of the present invention.

FIG. 9 shows cross-sections of a first blade, a first rib, and a second rib in the second preferred embodiment of the present invention.

FIG. 10 is a cross-sectional view of a counter-rotating fan according to a third preferred embodiment of the present invention.

FIG. 11 is a cross-sectional view of a counter-rotating fan according to a fourth preferred embodiment of the present invention.

FIG. 12 is a cross-sectional view of a variant of the counter-rotating fan of FIG. 11.

FIG. 13 is an exploded perspective view of the counter-rotating fan of FIG. 10.

FIG. 14 is an exploded perspective view of the counter-rotating fan of FIG. 11.

FIG. 15 shows a static pressure-flow relation (P-Q curve) measured for the counter-rotating fan of FIG. 11.

FIG. 16 shows an efficiency-flow relation measured for the counter-rotating fan of FIG. 11.

### DETAILED DESCRIPTION OF PREFERRED EMBODIMENTS

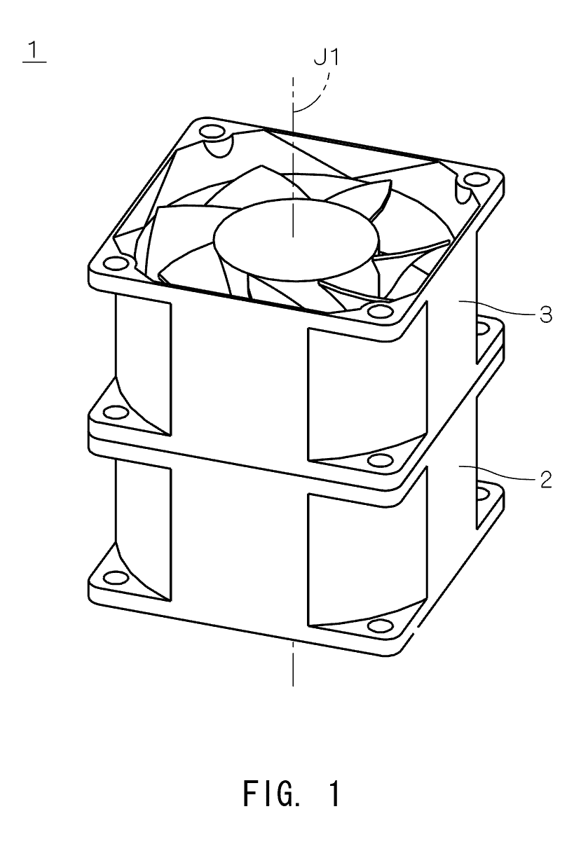

Referring to FIGS. 1 through 16, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

### First Preferred Embodiment

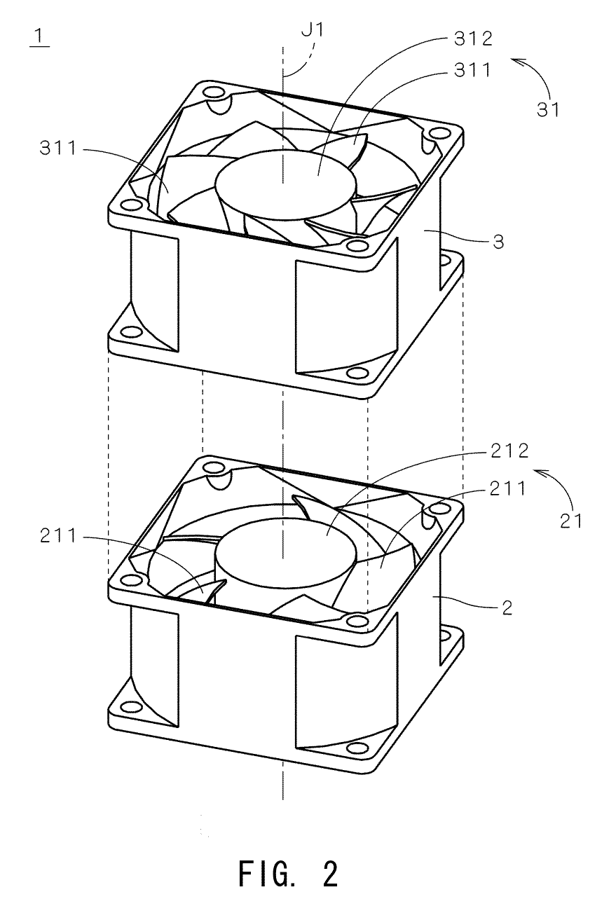

FIG. 1 is a perspective view of a counter-rotating fan 1 according to a first preferred embodiment of the present invention. FIG. 2 is an exploded view of the counter-rotating fan 1 of FIG. 1. The counter-rotating fan 1 is preferably used, for example, as an electric cooling fan which cools an electronic device such as a server, for example. As shown in FIG. 1, the counter-rotating fan 1 includes a first axial fan 2 and a second axial fan 3 which are coaxially arranged in series along a center axis J1 of the counter-rotating fan 1. In this preferred embodiment, the second axial fan 3 is arranged axially above the first axial fan 2, as shown in FIG. 1. The first and second axial fans 2 and 3 are secured to each other, for example, by screwing, or another fastening means or method.

When the first and second axial fans 2 and 3 are driven in the counter-rotating fan 1, air is taken in from above the second axial fan 3 and is sent downward in an axial direction that is substantially parallel or parallel to the center axis J1, i.e., toward the first axial fan 2, thereby creating a current of air flowing downward in the axial direction. In the following description, the upper side in FIG. 1 from which air is taken in is referred to as an “air-inlet side” and the lower side in FIG. 1 from which air is discharged is referred to as an “air-outlet side”. Moreover, the air-inlet side and the air-outlet side are also referred to as the second fan side and the first side of the counter-rotating fan.

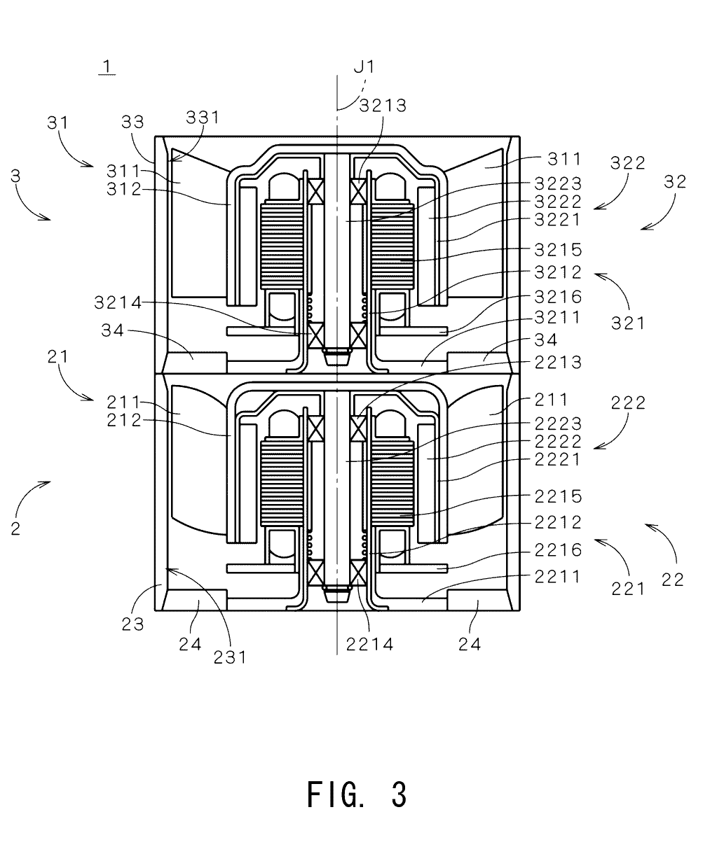

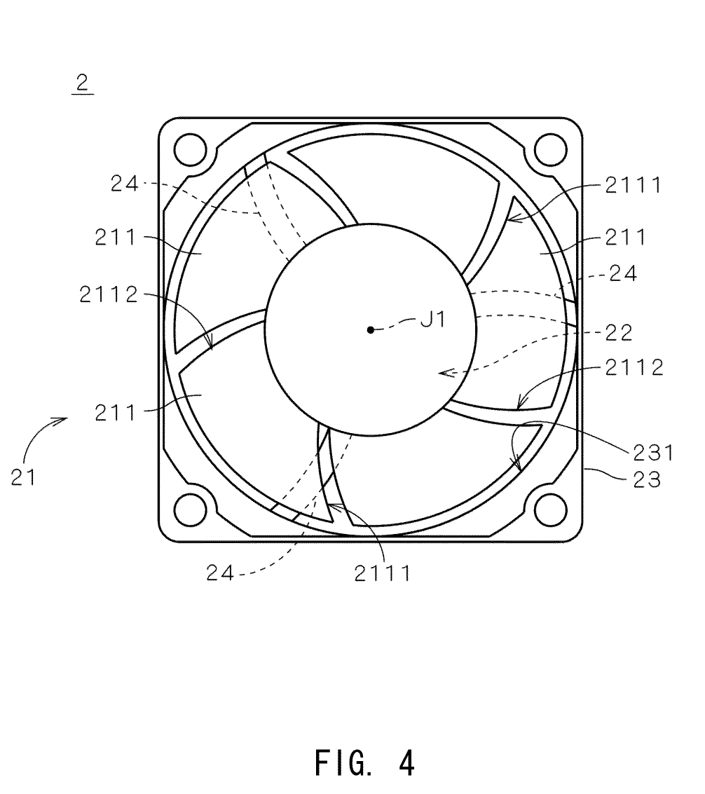

FIG. 3 is a cross-sectional view of the counter-rotating fan 1, taken along a plane containing the center axis J1. FIG. 4 is a plan view of the first axial fan 2 when seen from the air-inlet side.

As shown in FIGS. 3 and 4, the first axial fan 2 includes a first impeller 21 having a plurality of first blades 211, a first motor 22, a first housing member 23, and a plurality of first ribs 24. In this preferred embodiment, five first blades 211 and three first ribs 24 are preferably provided, for example. The first blades 211 are radially arranged about the center axis J1 at regular intervals. The first motor 22 rotates the first impeller 21 about the center axis J1 in a first rotating direction so as to create a current of air flowing in the axial direction. In the shown example, the first rotating direction is a counterclockwise direction in FIGS. 2 and 4. The current of air created by rotation of the first impeller 21 flows downward in the axial direction in FIG. 3. The first housing member 23 defines a hollow cylinder which accommodates the first impeller 21 and the first motor 22 therein. The first housing member 23 is arranged outside the first impeller 21 in a radial direction that is substantially perpendicular or perpendicular to the axial direction, thereby surrounding the first impeller 21. The first ribs 24 are radially arranged about the center axis J1 to connect the first motor 22 to the first housing member 23. In this manner, the first ribs 24 support the first motor 22.

Referring to FIG. 3, the first motor 22 includes a stator 221 as a stationary assembly and a rotor 222 as a rotating assembly. The rotor 222 is supported by a bearing assembly described later, in a rotatable manner about the center axis J1 relative to the stator 221. In the following description, the rotor side and the stator side in the axial direction are referred to as upper and lower sides in the axial direction for the sake of convenience, respectively. However, it is unnecessary that the axial direction is coincident with a direction of gravity.

The stator 221 includes a base portion 2211. The base portion 2211 has an approximately annular shape centered on the center axis J1 when seen in the axial direction. The base portion 2211 is secured to an inner side surface 231 of the first housing member 23 with the first ribs 24, as shown in FIGS. 3 and 4, and supports other components of the stator 221. The base portion 2211 is preferably made of resin and is preferably formed by injection molding together with the first ribs 24 and the first housing member 23 both of which are also preferably made of resin.

The base portion 2211 has an opening at its center. Referring to FIG. 3, a hollow, approximately cylindrical bearing holder 2212 is secured to a portion of the base portion 2211 defining the opening. The bearing holder 2212 extends upward (i.e., toward the rotor 222) from the base portion 2211. Inside the bearing holder 2212, ball bearings 2213 and 2214 are arranged in an upper portion and a lower portion in the axial direction, respectively. The ball bearings 2213 and 2214 define a portion of the bearing assembly.

The stator 221 also includes an armature 2215 arranged radially outside the bearing holder 2212. In the stator 221, a circuit board 2216 preferably in the form of an approximately annular plate is attached axially below the armature 2215 and is electrically connected to the armature 2215. A circuit (not shown) on the circuit board 2216 controls the armature 2215. The circuit board 2216 is connected to an external power supply provided outside the counter-rotating fan 1 via a bundle of lead wires. The bundle of lead wires and the external power supply are not shown in FIG. 3.

The rotor 222 includes a yoke 2221 made of magnetic metal. The yoke 2211 is hollow and approximately cylindrical, is centered on the center axis J1, and is provided with a lid for closing an axially upper end of the yoke 2211. In the rotor 222, a hollow, approximately cylindrical magnet 2222 for generating a magnetic field is secured to an inner surface of a sidewall of the yoke 2221, i.e., an inner side surface of the yoke 2221. The magnet 2222 is arranged to face the armature 2215.

The rotor 222 further includes a shaft 2223 extending from the lid of the yoke 2221 downward in the axial direction. The shaft 2223 is inserted into the bearing holder 2212 and is supported by ball bearings 2213 and 2214 in a rotatable manner. In the first axial fan 2, the shaft 2223 and the ball bearings 2213 and 2214 form the bearing assembly which supports the yoke 2221 in a rotatable manner about the center axis J1 relative to the base portion 2211.

The first impeller 21 includes a hollow, approximately cylindrical hub 212 which has a lid closing an axially upper end thereof. The hub 212 covers the outside of the yoke 2221 of the first motor 22. The first impeller 21 also includes a plurality of first blades 211 radially extending from the outside of a sidewall of the hub 212, i.e., an outer side surface of the hub 212. The hub 212 and the first blades 211 are preferably made of resin and are preferably formed by injection molding together.

In the first axial fan 2, a driving current is supplied to the armature 2215 via the circuit board 2216 of the first motor 22. This driving current is controlled, thereby generating a torque centered on the center axis J1 by interaction between the armature 2215 and the magnet 2222. The torque rotates the rotor 222 about the center axis J1 so as to turn the first blades 211 of the impeller 21 attached to the rotor 222 around the center axis J1 in a counterclockwise direction in FIG. 4. Thus, air is taken in from the upper side in FIG. 3, i.e., the second axial fan side and is sent to the lower side in FIG. 3, i.e., toward the first ribs 24.

Referring to FIG. 2, in the first impeller 21 of the first axial fan 2, a radially inner edge of each first blade 211 is located on an outer side surface of the hub 212 and is arranged at an angle relative to the center axis J1. The radially inner edge of each first blade 211 extends toward an upstream side in the rotating direction of the first impeller 21, as it moves from the air-inlet side to the air-outlet side along the center axis J1 (i.e., downward in the axial direction in FIG. 2). That is, the air-inlet side edge of each first blade 211 is located ahead of the air-outlet side edge thereof in the rotating direction of the first impeller 21 which is a counterclockwise direction in FIG. 4. Hereinafter, the air-inlet side edge 2111 and the air-outlet side edge 2112 of each first blade 211 are referred to as a leading edge and a trailing edge.

In the first axial fan 2, the first ribs 24 arranged on the air-outlet side of the first impeller 21 are radially arranged about the center axis J1 at regular intervals, as shown in FIG. 4. More specifically, both points of connection between the first ribs 24 and the first motor 22 and points of connection between the first ribs 24 and the first housing member 23 are regularly arranged about the center axis J1, respectively. Each first rib 24 is arranged at an angle relative to a line which extends from a radially inner end of that first rib 24 in the radial direction, so as to move farther away from that line in an opposite direction to the first rotating direction of the first impeller 21 as it moves away from the center axis J1.

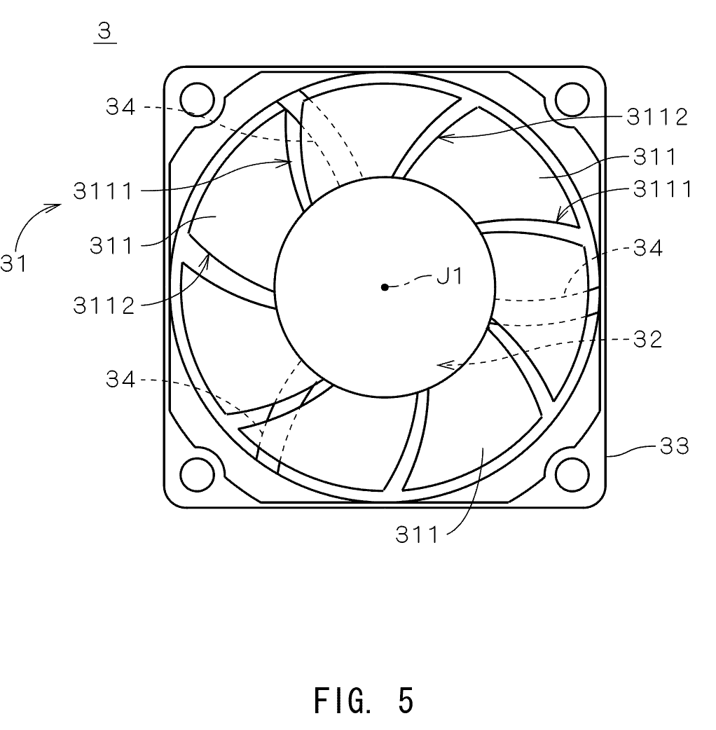

FIG. 5 is a plan view of the second axial fan 3 when seen from the air-inlet side (i.e., from the second fan side). Referring to FIGS. 3 and 5, the second axial fan 3 includes a second impeller 31 arranged adjacent to the first impeller 21 in the axial direction. The second impeller 31 has a plurality of second blades 311 radially arranged about the center axis J1 at regular intervals. In this preferred embodiment, seven second blades 311 are preferably provided, for example.

The second axial fan 3 also includes a second motor 32, a second housing member 33, and a plurality of second ribs 34. In this preferred embodiment, three second ribs 34 are preferably provided, for example. The second motor 32 rotates the second impeller 31 about the center axis J1 in a second rotating direction opposite to the first rotation direction of the first impeller 21 so as to create a current of air flowing in the same direction as that created by the first impeller 21. In the shown example, the second rotating direction is a clockwise direction in FIGS. 2 and 5. The current of air created by rotation of the second impeller 31 flows downward in the axial direction in FIG. 3. The second housing member 33 is arranged outside the second impeller 31 in the radial direction to surround the second impeller 31. The second housing member 33 has an inner side surface 331 defining a hollow cylinder in which the second impeller 31 and the second motor 32 are accommodated. The second ribs 34 are arranged between the first and second impellers 21 and 31, and radially extend from the second motor 32 to the second housing member 33. That is, the second ribs 34 connect the second motor 33 to the second housing member 33. In this preferred embodiment, the number of the second ribs 34 is equal to the number of the first ribs 24 (see FIG. 4).

The second motor 32 preferably has substantially the same structure as the first motor 22. Referring to FIG. 3, the second motor 32 includes a stator 321 and a rotor 322 arranged axially above the stator 321 (i.e., on the air-intake side of the stator 321). The second motor 322 is supported in a rotatable manner relative to the stator 321.

The stator 321 includes a base portion 3211 secured to the inner side surface 331 of the second housing member 33 with the second supporting ribs 34. The base portion 3211 supports other components of the stator 321. The stator 321 also includes a hollow, approximately cylindrical bearing holder 3212 with ball bearings 3213 and 3214 arranged therein, and an armature 3215 arranged outside the bearing holder 3212. A circuit board 3216, preferably in the form of an approximately annular plate, is disposed axially below the armature 3215. The circuit board 3216 is electrically connected to the armature 3215. A circuit (not shown) on the circuit board 3216 controls the armature 3215.

The base portion 3211 is preferably made of resin and is preferably formed by injection molding together with the second supporting ribs 34 and the second housing member 33 both of which are made of resin. The circuit board 3216 is connected to an external power supply provided outside the counter-rotating fan 1 via a bundle of lead wires.

The rotor 322 includes a metal yoke 3221, a magnet 3222 for generating a magnetic field, secured to an inner side surface of the yoke 3221, and a shaft 3223 extending downward from the yoke 3221. The shaft 3223 is supported by the ball bearings 3213 and 3214 in the bearing holder 3212 in a rotatable manner. In the second axial fan 3, the shaft 3223 and the ball bearings 3213 and 3214 define together a bearing assembly for supporting the yoke 3221 in a rotatable manner about the center axis J1 relative to the base portion 3211.

The second impeller 31 includes a hollow, approximately cylindrical hub 312 with a lid, and a plurality of second blades 311 radially extending from an outer side surface of the hub 312. The hub 312 covers the outside of the yoke 3221 of the second motor 32. The hub 312 and the second blades 312 are preferably made of resin and are preferably formed by injection molding together.

When the second motor 32 is driven in the second axial fan 3, the second blades 311 of the second impeller 31 are turned about the center axis J1 in a clockwise direction in FIG. 5. Thus, air is taken into the second axial fan 3 from above the second axial fan 3 (from above the rotor 322 of the second motor 32) and is discharged downward in the axial direction, i.e., toward the second ribs 34 and the first axial fan 2.

As shown in FIG. 2, a radially inner edge of each second blade 311 of the second impeller 31 is located on the outer side surface of the hub 312 and is arranged at an angle relative to the center axis J1 in a similar manner to that of the radially inner edge of each first blade 211 of the first impeller 21. The radially inner edge of each second blade 311 extends toward an upstream side in the rotating direction of the second impeller 31, as it moves from the air-inlet side to the air-outlet side along the center axis J1. That is, the air-inlet side edge 3111 of each second blade 31 is located ahead of the air-outlet side edge 3112 thereof in the rotating direction of the second impeller 31 (i.e., a clockwise direction in FIG. 5). Hereinafter, the air-inlet side edge 3111 and the air-outlet side edge 3112 of each second blade 311 are referred to as a leading edge and a trailing edge, respectively.

Referring to FIG. 5, in the second axial fan 3, the second ribs 34 on the air-outlet side of the second impeller 31 are radially arranged about the center axis J1 at regular intervals, as in the first axial fan 2. Each second rib 34 is at arranged an angle relative to a line which radially extends from a radially inner end of that second rib 34, so as to move farther away from that line in an opposite direction to the second rotating direction of the second impeller 31 as it moves away from the center axis J1.

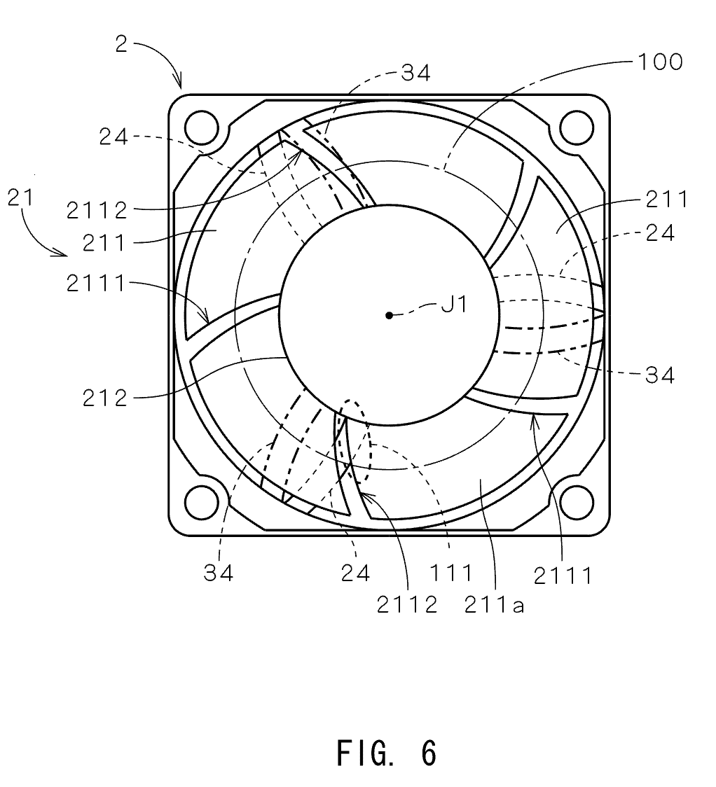

FIG. 6 is a plan view of the first axial fan 2 when seen from the air-inlet side (i.e., the second axial fan side). FIG. 6 also shows with chain double-dashed line the second ribs 34 of the second axial fan 3 which sandwich the first impeller 21 together with the first ribs 24 in the axial direction. In the counter-rotating fan 1, the entire portion of every first rib 24 is located between two second ribs 34 without being covered by any of the second ribs 34, when seen in the axial direction from the second fan side, as shown in FIG. 6.

In the state shown in FIG. 6, a trailing edge 2112 of one of five first blades 211 which is shown as the lowermost first blade 211a is partly located above one first rib 24, when seen in the axial direction from the second fan side. The trailing edge 2112 of the first blade 211a is a first rib side edge. As shown in FIG. 6, when seen from the second fan side, while a portion of the trailing edge 2112 of the first blade 211a is located axially above one first rib 24, the entire portion of the leading edge 2111 (i.e., the second rib side edge) of the first blade 211a is not located below any of the second ribs 34. Instead, the entire portion of the leading edge 2111 is located between two second ribs 34.

In the counter-rotating fan 1, the first blades 211, the first ribs 24, and the second ribs 34 are regularly arranged about the center axis J1 at respective intervals. Thus, while a portion of the trailing edge 2112 of each first blade 211 is located axially above a given first rib 24, the leading edge 2111 of that first blade 211 is located between two second ribs 34 without being covered by any of the second ribs 34, when seen from the second fan side in the axial direction.

Thus, simultaneous occurrence of interference of air introduced into the first axial fan 2 by the first blades 211 with the second ribs 34 and interference of air sent out by the first blades 211 with the first ribs 24 are reliably prevented. As a result, the sound characteristics of the counter-rotating fan 1 are greatly improved. In particular, a prominence ratio indicating a ratio of prominent discrete tone in audible areas, which is one of standards for evaluating the sound characteristics, is significantly reduced.

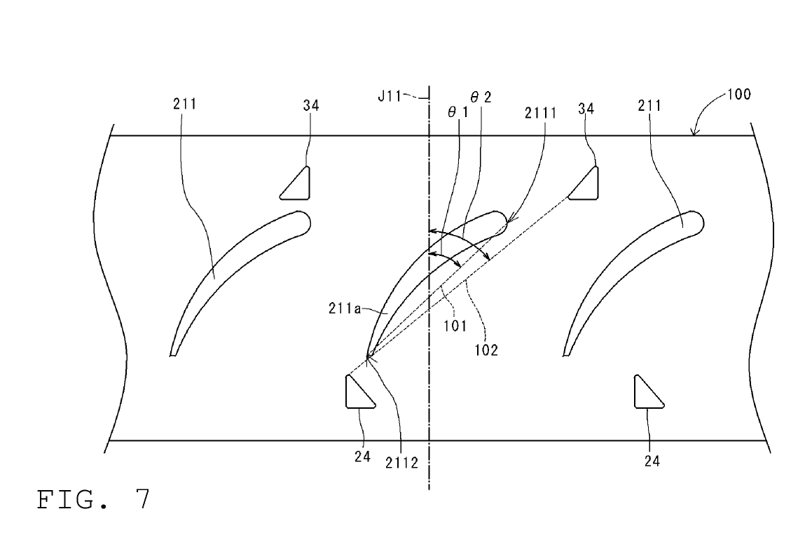

FIG. 7 is a cross-sectional view of the first blades 211, the first ribs 24, and the second ribs 34 of the counter-rotating fan 1, taken along a cylindrical surface 100 which defines a cylinder having a predetermined diameter and centered on the center axis J1 (shown with dashed-dotted line in FIG. 6). FIG. 7 shows cross sections of those members 211, 24, and 34 when a portion of the cylindrical surface 100 is developed in its circumferential direction. FIG. 7 also shows the axial direction J11.

In FIG. 7, a line 101 connects both ends of the first blade 211a, i.e., the leading edge 2111 and the trailing edge 2112 to each other on the cylindrical surface 100. On the developed surface 100, the line 101 is arranged at an angle θ1 relative to the axial direction J11. FIG. 7 also shows a line 102 on the surface 100, which connects the closest first rib 24 to the trailing edge 2112 of the first blade 211a to the closest second rib 34 to the leading edge 2111 of the first blade 211a on the developed cylindrical surface 100. The line 102 is arranged at an angle θ2 relative to the axial direction J11. In FIG. 7, both the lines 101 and 102 are shown with broken line.

As shown in FIG. 7, the angles θ1 and θ2 of the lines 101 and 102 with respect to the axial direction J11 on the developed cylindrical surface 100 are different from each other. Moreover, the angle θ1 of the line 101 is different from an angle of a line connecting a given first rib 24 to a given second rib 34 with respect to the axial direction J11 on the developed cylindrical surface 100. Even when the diameter of the cylinder defined by the cylindrical surface 100 is changed between an outer diameter of the hub 212 of the first impeller 21 (see FIG. 6) and an outer diameter of the first impeller 21, the angle θ1 of the line 101 connecting the leading and trailing edges 2111 and 2112 of the first blade 211a with respect to the center axis J1 is different from an angle of a line connecting a given first rib 24 to a given second rib 34 with respect to the center axis J1 on the developed cylindrical surface 100.

In the counter-rotating fan 1, all the first blades 211 are preferably arranged at the same angle relative to the center axis J1, and the first blades 211, the first ribs 24, and the second ribs 34 are regularly arranged at their own intervals, respectively. Thus, when the first blades 211, the first ribs 24, and the second ribs 34 are cut by a cylindrical surface which defines a cylinder having a given diameter and centered on the center axis J1, an angle of a line connecting leading and trailing edges of each first blade 211 with respect to the center axis J1 on the developed cylindrical surface is different from a line connecting a given first rib 24 to a given second rib 34 with respect to the axial direction J11 on the developed surface. In other words, for each first blade 211, both the first rib 24 and the second rib 34 cannot be simultaneously located on an extended line of the line connecting the leading and trailing edges of that first blade 211 to each other.

With this configuration, it is possible to prevent simultaneous occurrence of interference of air introduced into the first axial fan 2 by the first blades 211 with the second ribs 34 and interference of air sent out by the first blades 211 with the first ribs 24. Thus, the sound characteristics of the counter-rotating fan 1 are greatly improved. In particular, a prominence ratio is significantly reduced.

As described above, in the counter-rotating fan 1 of this preferred embodiment, the first impeller 21 sandwiched between the second ribs 34 on the air-inlet side and the first ribs 24 on the air-outlet side is designed to satisfy the following conditions. First, the leading edge 2111 of each first blade 211 is not located below a closest second rib 34 to that leading edge 2111 while the trailing edge 2112 of that first blade 211 is at least partly located above a closest first rib 24 to that trailing edge 2112, and vice versa. Second, the angle of each first blade 211 with respect to the center axis J1, i.e., the angle of the line connecting the leading and trailing edges of the first blade 211 with respect to the center axis J1 is different from the angle of the line connecting the closest first rib 24 to that first blade 211 to the closest second rib 24 to that first blade 211 with respect to the center axis J1. When the above two conditions are satisfied, the sound characteristics of the counter-rotating fan 1 can be improved. Moreover, it is preferable that no second rib 34 be located axially above each first rib 24. In this case, the sound characteristics of the counter-rotating fan 1 are improved even more.

In the counter-rotating fan 1 of this preferred embodiment, the number of the first ribs 24 is preferably equal to the number of the second ribs 34. Thus, the above two conditions for arranging the first blades 211, the first ribs 24, and the second ribs 34 can be easily satisfied. In other words, the arrangement of the first and second ribs suitable for improving the sound characteristics of the counter-rotating fan 1 can be easily achieved.

In the counter-rotating fan 1 of this preferred embodiment, each of the first ribs 24 arranged on the air-outlet side of the first impeller 21 is at an angle to a line extending from the radially inner end of that first rib 24 in the radial direction such that that first rib 24 moves farther away from that line in an opposite direction to the first rotating direction as it moves away from the center axis J1. Thus, air sent out by the first impeller 21 with the first ribs 24 can be further reduced. This improves the sound characteristics of the first axial fan 2. Moreover, each first rib 24 is curved so as to be convex toward a downstream side of the rotating direction of the first impeller 21 when seen in the axial direction. Thus, the sound characteristics of the first axial fan 2 are further improved.

In the second axial fan 3, each of the second ribs 34 arranged on the air-outlet side of the second impeller 31 is arranged at an angle relative to a line extending from the radially inner end of that second rib 34 in the radial direction such that that second rib 34 moves farther away from that line in an opposite direction to the second rotating direction of the second impeller 31 as it moves away from the center axis J1, as in the first axial fan 2. Thus, interference of air sent out by the second impeller 31 with the second ribs 34 is further reduced. This contributes to improvement of the sound characteristics of the second axial fan 3. Moreover, each second rib 34 is curved to be convex toward a downstream side of the rotating direction of the second impeller 31. This also contributes to improvement of the sound characteristics of the second axial fan 3.

In both the first and second axial fans 2 and 3, each of the first and second ribs 24 and 34 is arranged at an angle relative to the line extending from its radially inner end in the radial direction. Thus, spreading of air sent by the first and second impellers 21 and 31 in a direction away from the center axis J1 is reliably suppressed. This improves air-sending efficiency of the counter-rotating fan 1.

In the first axial fan 2, the first ribs 24 are radially arranged about the center axis J1 at regular intervals. Thus, the first motor 22 can be supported in a stable manner. Similarly, the second ribs 34 are radially arranged about the center axis J1 at regular intervals in the second axial fan 3. Thus, the second motor 32 can be supported in a stable manner.

In the counter-rotating fan 1 of this preferred embodiment, the first and second housing members 23 and 33 preferably are independently formed and are then secured to each other to form a hollow housing surrounding the first and second impellers 21 and 31 from radially outside thereof. Thus, it is easy to form the housing for the counter-rotating fan 1 and to attach the first and second impellers 21 and 31 and the first and second motors 22 and 32 to the housing.

### Second Preferred Embodiment

A counter-rotating fan according to a second preferred embodiment of the present invention is now described. Except for the arrangement of the first ribs 24 relative to the second ribs 34, the counter-rotating fan of this preferred embodiment is preferably substantially the same as the counter-rotating fan 1 of the first preferred embodiment. Like components are labeled with like reference numerals throughout the drawings.

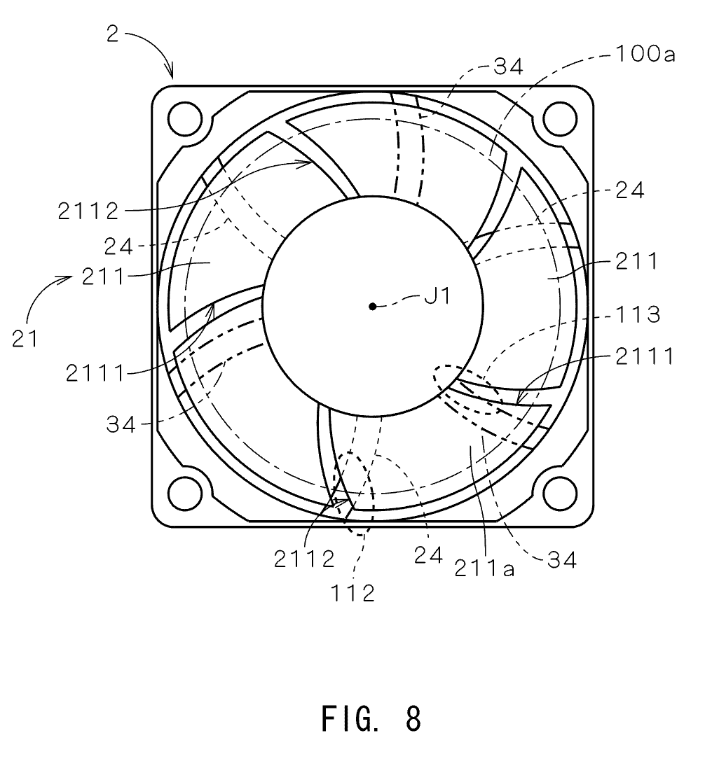

FIG. 8 is a plan view of the first axial fan 2 of the counter-rotating fan according to the second preferred embodiment, when seen from its air-inlet side. FIG. 8 also shows the second ribs 34 of the second axial fan 3 which sandwich the first impeller 21 with the first ribs 24 in the axial direction, with chain double-dashed line. FIG. 8 shows a state in which a radially outer portion of the trailing edge 2112 (the first rib side edge) of the first blade 211a is located above one first rib 24 in the axial direction, when seen from the above, as shown with broken line 112. Please note that a radially outer portion of an edge of a blade is a portion outside the center of that edge in the radial direction.

Referring to FIG. 8, when seen from the second fan side in the axial direction, while the radially outer portion of the trailing edge 2112 of the first blade 211a is located above the first rib 24, a radially inner portion of the leading edge 2111 (the second rib side edge) of that first blade 211a is located below one second rib 34, as shown with broken line 113. However, a radially outer portion of the leading edge 2111 is not located below any of the second ribs 34 but is located between two second ribs 34 when seen from axially above.

In the counter-rotating fan of this preferred embodiment, the first blades 211, the first ribs 24, and the second ribs 34 are regularly arranged about the center axis J1 at their own intervals. Thus, when seen from the second fan side in the axial direction, while the radially outer portion of the trailing edge 2112 of each first blade 211 is located axially above a given first rib 24, the radially outer portion of the leading edge 2111 of that first blade 211 is not located axially below any second rib 34 but is located between two second ribs 34.

With this configuration, air introduced into the first axial fan 2 by the first blades 211 with the second ribs 34 and air sent out from the first axial fan 2 by the first blades 211 with the first ribs 24 cannot simultaneously occur in the outside of the centers of the first blades 211 in the radial direction. In general, in counter-rotating axial fans, a flow rate of air is larger in the outside of the centers of the first blades 211 than in the inside of the centers (i.e., the center axis J1 side) in the radial direction. Thus, it is possible to improve the sound characteristics of the counter-rotating axial fan (especially, largely reduce a prominence ratio) by preventing simultaneous occurrence of interference of air with the air-inlet side ribs of the first blades 211 and interference of air with the air-outlet side ribs.

As shown in FIG. 8, in the counter-rotating fan of this preferred embodiment, the entire portion of each first rib 24 is not located axially below any second rib 34 when seen from axially above, as in the first preferred embodiment. Instead, each first rib 24 is entirely located between two second ribs 34 when seen from axially above. Thus, the sound characteristics of the counter-rotating fan are improved.

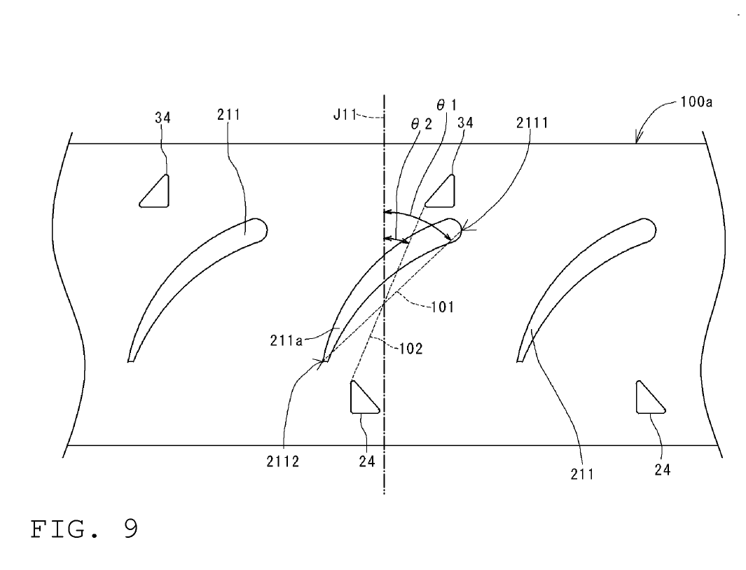

FIG. 9 is a cross-sectional view of the first blades 211, the first ribs 24, and the second ribs 34 of the counter-rotating fan of this preferred embodiment, taken along a cylindrical surface 100a which defines a cylinder having a predetermined diameter and centered on the center axis J1. The cylindrical surface 100a is shown in FIG. 8 with dashed dotted line. In FIG. 9, a portion of the cylindrical surface 100a is developed in the circumferential direction. The cylindrical surface 100a is located outside the centers of the first blades 211 in the radial direction. FIG. 9 also shows the axial direction J11 parallel or substantially parallel to the center axis J1.

As shown in FIG. 9, a line 101 connects the leading edge 2111 and the trailing edge 2112 of one first blade 211a to each other on the cylindrical surface 100a, and a line 102 connects a closest first rib 24 to the trailing edge 2112 of that first blade 211a and a closest second rib 34 to the leading edge 2111 of that first blade 211a on the cylindrical surface 100a. An angle θ1 of the line 101 and an angle θ2 of the line 102 with respect to the axial direction J11 are different from each other.

The angle θ1 of the line 101 is different from an angle of a line connecting a given first rib 24 to a given second rib 34 on the developed cylindrical surface 100a with respect to the axial direction J11. In the counter-rotating fan of this preferred embodiment, even when the diameter of the cylinder defined by the cylindrical plane 100a is changed to a given diameter between a diameter of a circle which passes through the center of every first blade 211a in the radial direction and an outer diameter of the first impeller 21, the angle θ1 of the line 101 on the developed cylindrical surface 100a with respect to the axial direction J11 is different from the angle of the line connecting a given first rib 24 to a given second rib 34 on the developed cylindrical surface 100a with respect to the axial direction J11.

In this preferred embodiment, all the first blades 211a are preferably arranged at the same angle relative to the center axis J1. The first blades 211a, the first ribs 24, and the second ribs 34 are regularly arranged about the center axis J1 at respective intervals, as in the first preferred embodiment. Thus, when the radially outer portion of each first blade 211, the first ribs 24, and the second ribs 34 are cut by a cylindrical surface which defines a cylinder centered on the center axis J1 and having a given diameter, the angle of the line connecting the leading and trailing edges of each first blade 211 on the developed cylindrical surface 100a with respect to the center axis J1 is different from the angle of the line connecting a given first rib 24 to a given second rib 34 on the cylindrical surface 100 with respect to the center axis J1. In other words, in the counter-rotating fan of this preferred embodiment, both the first rib 24 and the second rib 34 cannot be simultaneously located on an extended line of the line connecting the leading and trailing edges of each first blade 211 to each other in the outside of the radial centers of the first blades 211.

As a result, it is possible to prevent simultaneous occurrence of interference of air taken in by the first blades 211 with the second ribs 34 and interference sent out by the first blades 211 with the first ribs 24 in the outside of the radial centers of the first blades 211. Thus, the sound characteristics of the counter-rotating fan are greatly improved, and in particular, a prominence ratio is significantly reduced.

As described above, in order to further improve the sound characteristics more reliably in counter-rotating axial fans, it is preferable that, when seen from axially above, while a portion of the trailing edge 2112 of the first blade 211 is located axially above one first rib 24, the leading edge 2111 of that first blade 211 is entirely located between second ribs 34 adjacent to each other, as described in the first preferred embodiment. It is also preferable that the angle of the line connecting the leading and trailing edges of each first blade 211 with respect to the center axis J1 on the developed cylindrical surface which defines a cylinder having a given diameter and centered on the center axis J1 be different from the angle of the line connecting a given first rib 24 to a given second rib 34 on the developed cylindrical surface with respect to the center axis J1.

If the first ribs 24 cannot be arranged relative to the second ribs 34 in the same manner as that in the first preferred embodiment because of structural limitations and the like, the first ribs 24 and the second ribs 34 are arranged not to cover or be covered by the first blade 211 at the same time. In other words, the first and second ribs 24 and 34 are arranged such that the leading edge of each first blade 211 is not located below any second rib 34 while the trailing edge of that first blade 211 is at least partly located above one first rib 24 and vise versa. In addition, the angle of the line connecting the leading and trailing edges 2111 and 2112 of the first blade 211 to each other is set to be different from the angle of the line connecting the first rib 24 and the second rib 34 to each other. That is, the arrangement of the first blades 211, the first ribs 24, and the second ribs 34 in the second preferred embodiment is preferably used. With this configuration, the sound characteristics of the second axial fan 3 can be sufficiently improved.

Although the preferred embodiments of the present invention are described above, the present invention is not limited thereto but can be modified in various ways.

In the first and second preferred embodiments, cross-sectional shapes of the first and second ribs 24 and 34 on the developed cylindrical surface which defines a cylinder centered on the center axis J1 preferably are approximately triangular. However, the cross-sectional shapes of the first and second ribs 24 and 34 are not limited thereto. For example, the first and second ribs 24 and 34 may have such a cross-sectional shape allowing them to serve as stationary blades which further suppress spreading out of air sent out from the first and second impellers 21 and 31 in a direction away from the center axis J1.

It is not necessary that the number of the first ribs 24 is equal to the number of the second ribs 34. For example, four first ribs 24 and three second ribs 34 may be provided in the first axial fan 2 and the second axial fan 3, respectively.

In the counter-rotating fans of the above first and second preferred embodiments, the first and second housing members 23 and 33 are preferably secured to each other to form a housing. However, this housing may be formed by a single component.

In the counter-rotating fans, air may be taken therein from below the first axial fan 2 in FIG. 3 and discharged axially upward by changing the shapes, arrangement, and the turning direction of the first blades 211 and the second blades 311 in the first impeller 21 and the second impeller 31.

### Third Preferred Embodiment

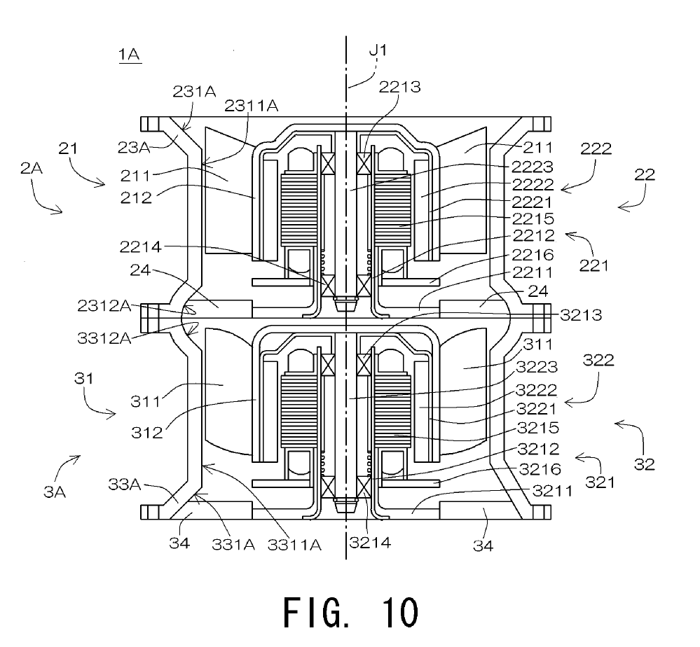

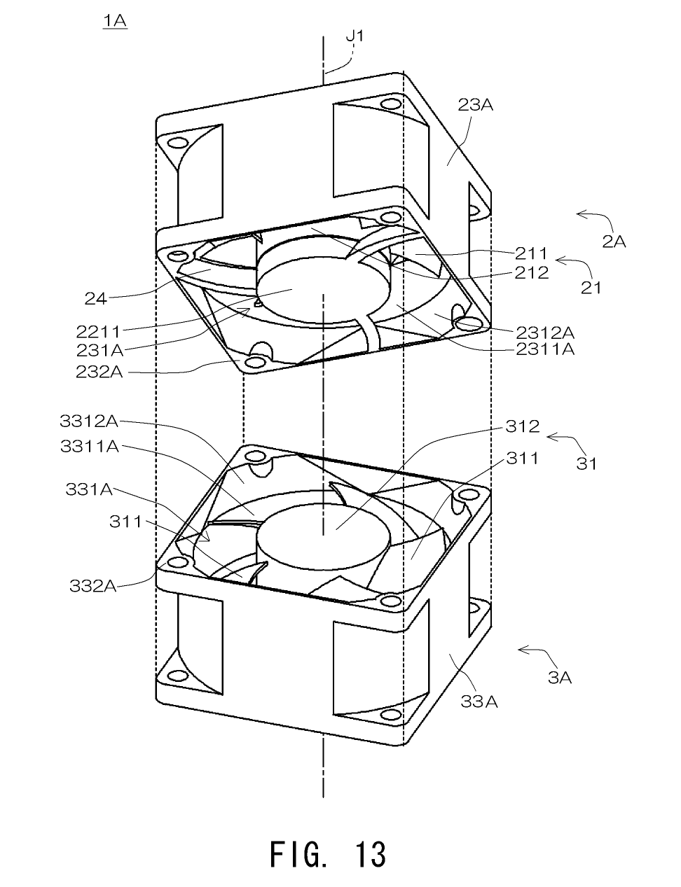

A counter-rotating axial fan according to a third preferred embodiment of the present invention is now described. FIG. 10 is a cross-sectional view of the counter-rotating axial fan 1A of the third preferred embodiment, cut along a plane containing a center axis J1 of the counter-rotating axial fan 1A and a diagonal connecting two opposite corners of four-sided counter-rotating axial fan 1A when viewed from axially above. FIG. 13 is an exploded perspective view of the counter-rotating fan 1A of FIG. 10. In FIG. 13, joining surfaces of the first axial fan 2A and the second axial fan 3A of the counter-rotating fan 1A are shown. It should be noted like reference numerals refer to like components throughout the drawings.

The counter-rotating axial fan 1A is preferably used for an electric cooling fan for cooling an electronic device such as a server by sending an air flow, like the counter-rotating fan 1 of the first preferred embodiment.

As shown in FIG. 10, the counter-rotating axial fan 1A includes the first axial fan 2A and the second axial fan 3A connected to the first axial fan 2A. The first and second axial fans 2A and 3A are arranged in the axial direction. In this preferred embodiment, the first axial fan 2A is located above the second axial fan 3A. Connection between the first axial fan 2A and the second axial fan 3A is achieved preferably by using a screw (not shown), for example. Please note that the manner of connecting the first and second axial fans 2A and 3A to each other is not limited thereto.

When the first and second axial fans 2A and 3A are driven in the counter-rotating fan 1A, air is taken in from above the first axial fan 2A and is sent downward in the axial direction, i.e., toward the second axial fan 3A, thereby creating a current of air flowing in the axial direction. In the following description, the upper side in FIG. 10 from which air is taken in is referred to as an “air-inlet side” and the lower side in FIG. 10 from which air is discharged is referred to as an “air-outlet side”.

The first axial fan 2A includes a first impeller 21 having a plurality of first blades 211, a first motor 22, a first housing member 23A, and a plurality of first ribs 24. In this preferred embodiment, seven first blades 211 and three first ribs 24 are preferably provided, for example. The first blades 211 are radially arranged about the center axis J1 at regular intervals. The first motor 22 rotates the first impeller 21 about the center axis J1 in a first rotating direction so as to create a current of air flowing in the axial direction. In the shown example, the first rotating direction is a counterclockwise direction when the counter-rotating fan 1A is viewed from the air-inlet side thereof. The current of air created by rotation of the first impeller 21 flows axially downward, i.e., downward in FIG. 10. The first housing member 23A defines a hollow cylinder which accommodates the first impeller 21 and the first motor 22 therein. The first housing member 23A is arranged outside the first impeller 21 in a radial direction that is substantially perpendicular or perpendicular to the axial direction, thereby surrounding the first impeller 21. The first ribs 24 are radially arranged about the center axis J1 to connect the first motor 22 to the first housing member 23A. In this manner, the first ribs 24 support the first motor 22.

Referring to FIG. 10, the first motor 22 includes a stationary assembly including a stator 221 and a rotating assembly including a rotor 222. The rotor 222 is supported by a bearing assembly described later, in a rotatable manner about the center axis J1 relative to the stator 221.

The stator 221 includes a base portion 2211. The base portion 2211 has an approximately annular shape centered on the center axis J1 when viewed in the axial direction. The base portion 2211 is secured to an inner side surface 231A of the first housing member 23A with the first ribs 24, as shown in FIG. 10, and supports other components of the stator 221. The base portion 2211 is preferably made of resin and is preferably formed by injection molding together with the first ribs 24 and the first housing member 23A both of which are also preferably made of resin. The first housing member 23A defines an approximately columnar hollow therein.

The base portion 2211 has an opening at its center. Referring to FIG. 10, a hollow, approximately cylindrical bearing holder 2212 is secured to a portion of the base portion 2211 defining the opening. The bearing holder 2212 extends upward (i.e., toward the rotor 222) from the base portion 2211. Inside the bearing holder 2212, ball bearings 2213 and 2214 are arranged in an upper portion and a lower portion in the axial direction, respectively. The ball bearings 2213 and 2214 define a portion of the bearing assembly.

The stator 221 also includes an armature 2215 arranged radially outside the bearing holder 2212. In this preferred embodiment, the armature 2215 is secured to the base portion 2211 around the bearing holder 2212. A circuit board 2216 preferably in the form of an approximately annular plate is attached axially below the armature 2215 and is electrically connected to the armature 2215. A circuit (not shown) on the circuit board 2216 controls the armature 2215. The circuit board 2216 is connected to an external power supply provided outside the counter-rotating fan 1A via a bundle of lead wires. The bundle of lead wires and the external power supply are not shown in FIG. 10.

The rotor 222 includes a yoke 2221 made of magnetic metal. The yoke 2211 is hollow and approximately cylindrical, is centered on the center axis J1, and is provided with a lid for closing an axially upper end of the yoke 2211. In the rotor 222, a hollow, approximately cylindrical magnet 2222 for generating a magnetic field is secured to an inner surface of a sidewall of the yoke 2221, i.e., an inner side surface of the yoke 2221. The magnet 2222 is arranged to face the armature 2215.

The rotor 222 further includes a shaft 2223 extending from the lid of the yoke 2221 downward in the axial direction. The shaft 2223 is inserted into the bearing holder 2212 and is supported by ball bearings 2213 and 2214 in a rotatable manner. In the first axial fan 2A, the shaft 2223 and the ball bearings 2213 and 2214 define the bearing assembly which supports the yoke 2221 in a rotatable manner about the center axis J1 relative to the base portion 2211.

The first impeller 21 includes a hollow, approximately cylindrical hub 212 which has a lid closing an axially upper end thereof. The hub 212 covers the outside of the yoke 2221 of the first motor 22. The first impeller 21 also includes a plurality of first blades 211 radially extending from the outside of a sidewall of the hub 212, i.e., an outer side surface of the hub 212. The hub 212 and the first blades 211 are preferably made of resin and are preferably formed by injection molding together.

In the first axial fan 2A, a driving current is supplied to the armature 2215 via the circuit board 2216 of the first motor 22. This driving current is controlled, thereby generating a torque centered on the center axis J1 by interaction between the armature 2215 and the magnet 2222. The torque rotates the rotor 222 about the center axis J1 so as to turn the first blades 211 of the impeller 21 attached to the rotor 222 around the center axis J1 in a counterclockwise direction when the counter-rotating axial fan 1A is viewed from the air-inlet side, i.e., the upper side in FIG. 10. Thus, air is taken in from the upper side in FIG. 10, i.e., the air-inlet side and is sent to the lower side in FIG. 10, i.e., toward the air-outlet side.

In the first axial fan 2A, the first ribs 24 arranged between the first impeller 21 and the second impeller 31 are radially arranged about the center axis J1 at regular intervals. More specifically, both points of connection between the first ribs 24 and the first motor 22 and points of connection between the first ribs 24 and the first housing member 23A are regularly arranged about the center axis J1, respectively. Each first rib 24 is arranged at an angle relative to a line which extends from a radially inner end of that first rib 24 in the radial direction, so as to move farther away from that line in an opposite direction to the rotating direction of the first impeller 21 as it moves away from the center axis J1.

Referring to FIG. 10, the second axial fan 3A includes a second impeller 31 which is centered on the center axis J1 and arranged axially adjacent to the first impeller 21. The second impeller 31 has a plurality of second blades 311 radially arranged about the center axis J1 at regular intervals. In this preferred embodiment, five second blades 311 are preferably provided, for example.

The second axial fan 3A also includes a second motor 32, a second housing member 33A, and a plurality of second ribs 34. In this preferred embodiment, three second ribs 34 are preferably provided, for example. That is, the number of the second ribs 34 is preferably the same as that of the first ribs 24 in this preferred embodiment. The second motor 32 rotates the second impeller 31 about the center axis J1 in a second rotating direction opposite to the first rotation direction of the first impeller 21 so as to create a current of air flowing in the same direction as that created by the first impeller 21. In the shown example, the second rotating direction is a clockwise direction when the counter-rotating axial fan 1A is viewed from the air-inlet side, i.e., the upper side in FIG. 10. The current of air created by rotation of the second impeller 31 flows downward in the axial direction. The second housing member 33A is arranged outside the second impeller 31 in the radial direction to surround the second impeller 31. The second housing member 33A has an inner side surface 331A defining a hollow cylinder in which the second impeller 31 and the second motor 32 are accommodated. The second ribs 34 are arranged on a side of the second impeller 31 opposite to the first impeller 21, and radially extend from the second motor 32 to the second housing member 33A. That is, the second ribs 34 connect the second motor 32 to the second housing member 33A.

The second motor 32 preferably has substantially the same structure as the first motor 22. Referring to FIG. 10, the second motor 32 includes a stator 321 and a rotor 322 supported in a rotatable manner relative to the stator 321.

The stator 321 includes a base portion 3211 secured to the inner side surface 331A of the second housing member 33A with the second ribs 34. The base portion 3211 supports other components of the stator 321. The stator 321 also includes a hollow, approximately cylindrical bearing holder 3212 with ball bearings 3213 and 3214 arranged therein, and an armature 3215 arranged outside the bearing holder 3212. A circuit board 3216 preferably in the form of an approximately annular plate is attached axially below the armature 3215. The circuit board 3216 is electrically connected to the armature 3215. A circuit (not shown) on the circuit board 3216 controls the armature 3215.

The base portion 3211 is preferably made of resin and is preferably formed by injection molding together with the second ribs 34 and the second housing member 33A both of which are made of resin. The circuit board 3216 is connected to an external power supply provided outside the counter-rotating fan 1A via a bundle of lead wires.

The rotor 322 includes a metal yoke 3221, a magnet 3222 for generating a magnetic field, secured to an inner side surface of the yoke 3221, and a shaft 3223 extending downward from the yoke 3221. The shaft 3223 is supported by the ball bearings 3213 and 3214 in the bearing holder 3212 in a rotatable manner. In the second axial fan 3A, the shaft 3223 and the ball bearings 3213 and 3214 together define a bearing assembly for supporting the yoke 3221 in a rotatable manner about the center axis J1 relative to the base portion 3211.

The second impeller 31 includes a hollow, approximately cylindrical hub 312 with a lid, and a plurality of second blades 311 radially extending from an outer side surface of the hub 312. The hub 312 covers the outside of the yoke 3221 of the second motor 32. The hub 312 and the second blades 312 are preferably made of resin and are preferably formed by injection molding together.

In the second axial fan 3A, the second motor 32 is driven by a driving current supplied from the outside of the second axial fan 3A, thereby turning the second blades 311 of the second impeller 31 around the center axis J1 in a clockwise direction when the counter-rotating axial fan 1A is viewed from the air-inlet side, i.e., the upper side in FIG. 10. Thus, air is taken in from the upper side in FIG. 10, i.e., the rotor 322 side and is sent to the lower side in FIG. 10, i.e., toward the air-outlet side.

In the second axial fan 3A, the second ribs 34 arranged on the air-outlet side of the second impeller 31 are radially arranged about the center axis J1 at regular intervals. Each second rib 34 is arranged at an angle relative to a line which extends from a radially inner end of that second rib 34 in the radial direction, so as to move farther away from that line in an opposite direction to the rotating direction of the second impeller 31 as it moves away from the center axis J1.

A specific exemplary shape of the first and second housing members 23A and 33A is now described. Each of the first and second housing members 23A and 33A preferably has an approximately rectangular outer shape when viewed from the air-inlet side. The first and second housing members 23A and 33A are joined to each other such that an air-outlet side end surface 232A (hereinafter, referred to as a first joining surface 232A) of the first housing member 23A is in contact with an air-inlet side end surface 332A (hereinafter, referred to as a second joining surface 332A) of the second housing member 33A in the axial direction, thereby defining a housing for the counter-rotating axial fan 1A of this preferred embodiment.

The inner side surface 231A of the first housing member 23A has a first surrounding portion 2311A which is substantially parallel to the center axis J1. The first surrounding portion 2311A surrounds the first impeller 21 and includes at least an axial middle of the first housing member 23A. On the air-outlet side of the first surrounding portion 2311A, four first inclined surfaces 2312A are preferably formed at four corners, for example. The first inclined surfaces 2312A are inclined with respect to the center axis J1 such that they move away from the center axis J1 as they move toward the air-outlet side. Except for at the four corners, the inner side surface 2311A of the first housing member 23A is substantially parallel to the center axis J1 also on the air-outlet side of the first surrounding portion 2311A in this preferred embodiment.

Similarly, the inner side surface 331A of the second housing member 33A has a second surrounding portion 3311A which is substantially parallel to the center axis J1. The second surrounding portion 3311A surrounds the second impeller 31 and includes at least an axial middle of the second housing member 33A. On the air-inlet side of the second surrounding portion 3311A, four second inclined surfaces 3312A are preferably formed at four corners, for example. The second inclined surfaces 2312A are inclined with respect to the center axis J1 such that they move away from the center axis J1 as they move toward the air-outlet side. Except for at the four corners, the inner side surface 3311A of the second housing member 33A is substantially parallel to the center axis J1 also on the air-inlet side of the second surrounding portion 3311A in this preferred embodiment.

A boundary between the first inclined surfaces 2312A and the first joining surface 232A is located substantially above a boundary between the second inclined surfaces 3312A and the second joining surface 332A in this preferred embodiment. In other words, when viewed from the air-inlet side (upper side in FIG. 10) of the counter-rotating axial fan 1A, the boundary between the first inclined surfaces 2312A and the first joining surface 232A covers the boundary between the second inclined surface 3312A and the second joining surface 332A. In addition, an angle of a tangent line of each first inclined surface 2312A with respect to the center axis J1 at the boundary with the first joining surface 232A is substantially the same as that of each second inclined surface 3312A at the boundary with the second joining surface 332A.

Since the first inclined surfaces 2312A are provided, the space defined in the first housing member 23A expands in a portion adjacent to the first joining surface 232A in which the first inclined surfaces 2312A are arranged. Hereinafter, the portion of the first housing member 23A is referred as a first expanding portion. Similarly, the second housing member 33A expands in a portion adjacent to the second joining surface 332A in which the second inclined surfaces 3312A are arranged. The portion of the second housing member 33A is hereinafter referred to as a second expanding portion. The first and second expanding portions together define a single expanding portion of the housing of the counter-rotating axial fan 1A, as shown in FIG. 10. The details of the expanding portion are described referring to FIGS. 10 and 13.

The first expanding portion formed by the first inclined surfaces 2312A are formed to gradually increase an area of a cross section of an air path substantially perpendicular to the center axis J1 as the first expanding portion moves toward the first joining surface 232A. The cross-sectional area of the air path is the largest at the first joining surface 232A. Similarly, the second expanding portion formed by the second inclined surfaces 3312A are formed to gradually increase the cross-sectional area of the air path as the second expanding portion moves toward the second joining surface 332A. The cross-sectional area of the air path is the largest at the second joining surface 332A. As described above, the expanding portion of each housing member 23A or 33A is formed by the inclined surfaces 2312A or 3312A in each of which the cross-sectional area of the air path increases as the housing member moves toward its joining surface.

In other words, in this arrangement, the area of the cross section of the air path that is substantially perpendicular to the center axis J1 is larger in the expanding portion (in the first and second expanding portions) than that of the air path surrounded by the first and second surrounding portions 2311A and 3311A. Therefore, the cross-sectional area of the air path is larger than in the expanding portion than in the axially middle portions of the first and second housing members 23A and 33A.

With this arrangement, each of the first housing member 23A and the second housing member 33A can be formed from resin by injection molding by using only two mold pieces, e.g., upper and lower molds, which can be separated from each other in the axial direction of the housing member. The upper and lower mold pieces are slidable in the axial direction of the housing member 23A or 33A to be molded and define a closed space when brought into contact with each other. The closed space defined by the mold pieces has the same shape as that of the housing member 23A or 33A. In injection molding, molten resin is injected into the closed space, and is then cooled down. After the resin is cooled, the upper mold piece is separated from the lower mold piece in the axial direction of the housing member 23A or 33A to be molded. In this manner, the housing member 23A or 33A can be formed.

Here, a case is assumed where a molded product has a blind portion when viewed along its center axis J1. In this case, it is not possible to mold the product only by upper and lower mold pieces which are slidable in the axial direction of the product. Instead, it is necessary to carry out so-called “undercut molding” that uses another mold piece called as a “slide core” slidable in a different direction from the axial direction of the product to be molded. However, the undercut molding increases the cost of the mold pieces and may lower the quality of the product. Therefore, it is preferable to mold the product without performing undercut molding.

In this preferred embodiment, the first housing member 23A and the second housing member 33A have the expanding portion 2312A and 3312A each having the aforementioned shape. Thus, it is possible to mold the first housing member 23A and the second housing member 33A without undercut molding. This is advantageous in reduction in the cost required for manufacturing mold pieces and improvement of the quality of the product to be molded.

When an air flow is generated by rotation of the first impeller 21, a centrifugal force acts on the air flow. Thus, the air flow contains a radially outward velocity component directed outward in the radial direction. Since the first expanding portion of the first housing member 23A and the second expanding portion of the second housing member 33A are joined to each other to form a single expanding portion as described above, the air flow can flow outward in the radial direction easily and more smoothly. Thus, the power consumption of the first motor 22 for rotating the first impeller 21 can be reduced. Moreover, air flowing along the first inclined surfaces 2312A of the first expanding portion is guided by the second inclined surfaces 3312A of the second expanding portion toward the second impeller 31. Thus, a created turbulent air flow is small. Accordingly, air can be efficiently discharged by the second impeller 31 from the second housing member 33A.

### Fourth Preferred Embodiment

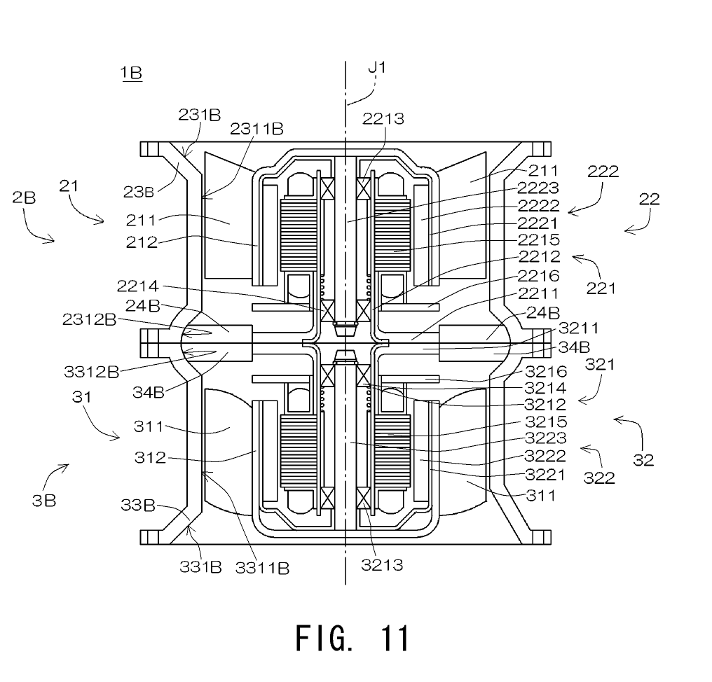

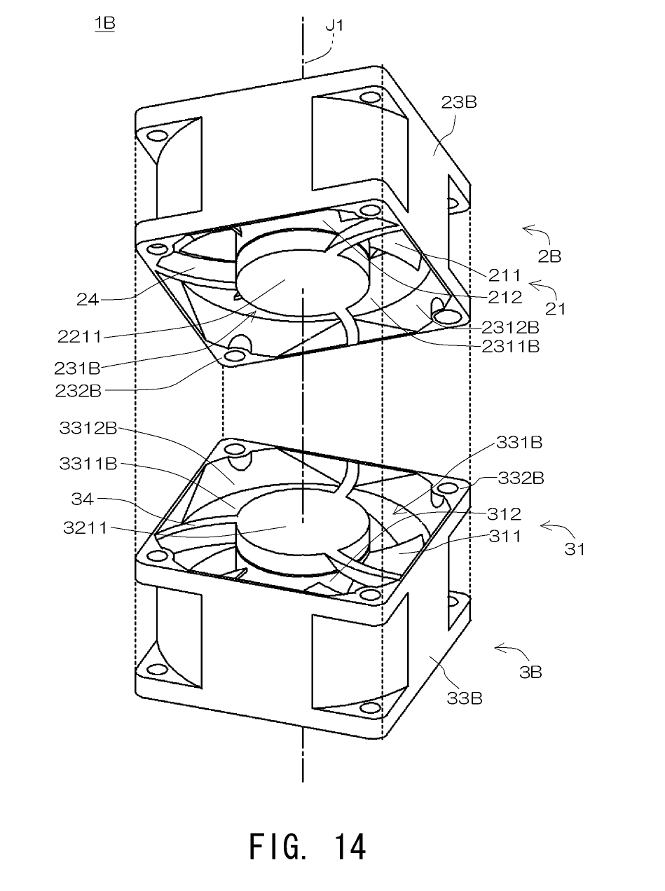

A counter-rotating axial fan according to a fourth preferred embodiment of the present invention is now described, referring to FIGS. 11 and 14. FIG. 11 is a cross-sectional view of the counter-rotating axial fan 1B of the fourth preferred embodiment, cut along a plane containing the center axis J1 and a diagonal connecting two opposite corners of four-sided counter-rotating axial fan 1B when viewed from axially above. FIG. 14 is an exploded perspective view of the counter-rotating fan 1B of FIG. 11. In FIG. 14, joining surfaces of the first axial fan 2B and the second axial fan 3B of the counter-rotating fan 1B are shown.

The counter-rotating axial fan 1B of this preferred embodiment preferably has the same structure as that of the third preferred embodiment shown in FIGS. 10 and 13, except for the arrangement of the second ribs 34. Therefore, in FIGS. 11 and 14, the same components as those in the third preferred embodiment are labeled with the same reference numerals as those in FIGS. 10 and 13. In the following description, differences between the third preferred embodiment and this preferred embodiment are mainly described.

In the first axial fan 2B, the first ribs 24B arranged between the first impeller 21 and the second impeller 31 described later are radially arranged about the center axis J1 at regular intervals. More specifically, both points of connection between the first ribs 24B and the first motor 22 and points of connection between the first ribs 24B and the first housing member 23B are regularly arranged about the center axis J1, respectively. Each first rib 24B is arranged at an angle relative to a line which extends from a radially inner end of that first rib 24B in the radial direction, so as to move farther away from that line in an opposite direction to the rotating direction of the first impeller 21 as it moves away from the center axis J1.

In the second axial fan 3B, the second ribs 34B arranged between the first impeller 21 and the second impeller 31 are radially arranged about the center axis J1 at regular intervals. Each second rib 34 is arranged at an angle relative to a line which extends from a radially inner end of that second rib 34 in the radial direction, so as to move farther away from that line in an opposite direction to the rotating direction of the second impeller 31 as it moves away from the center axis J1. As described above, both the first and second ribs 24B and 34B are arranged between the first and second impellers 21 and 31.

A specific exemplary shape of the first and second housing members 23B and 33B in this preferred embodiment is now described. Each of the first and second housing members 23B and 33B has an approximately rectangular outer shape when viewed from the air-inlet side. The first and second housing members 23B and 33B are joined to each other such that an air-outlet side end surface 232B (hereinafter, referred to as a first joining surface 232B) of the first housing member 23B is in contact with an air-inlet side end surface 332B (hereinafter, referred to as a second joining surface 332B) of the second housing member 33B in the axial direction, thereby forming a housing for the counter-rotating axial fan 1B of this preferred embodiment.

The inner side surface 231B of the first housing member 23B has a first surrounding portion 2311B which is substantially parallel to the center axis J1. The first surrounding portion 2311B surrounds the first impeller 21 and includes at least an axial middle of the first housing member 23B. On the air-outlet side of the first surrounding portion 2311B, four first inclined surfaces 2312B are preferably formed at four corners, for example. The first inclined surfaces 2312B are inclined with respect to the center axis J1 such that they move away from the center axis J1 as they move toward the air-outlet side. Except for at the four corners, the inner side surface 2311B of the first housing member 23B is substantially parallel to the center axis J1 also on the air-outlet side of the first surrounding portion 2311B in this preferred embodiment.

Similarly, the inner side surface 331B of the second housing member 33B has a second surrounding portion 3311B which is substantially parallel to the center axis J1. The second surrounding portion 3311B surrounds the second impeller 31 and includes at least an axial middle of the second housing member 33B. On the air-inlet side of the second surrounding portion 3311B, four second inclined surfaces 3312B are preferably formed at four corners, for example. The second inclined surfaces 2312B are inclined with respect to the center axis J1 such that they move away from the center axis J1 as they move toward the air-outlet side. Except for at the four corners, the inner side surface 3311B of the second housing member 33B is substantially parallel to the center axis J1 also on the air-inlet side of the second surrounding portion 3311B in this preferred embodiment.

A boundary between the first inclined surfaces 2312B and the first joining surface 232B is located substantially above a boundary between the second inclined surfaces 3312B and the second joining surface 332B in this preferred embodiment. In other words, when viewed from the air-inlet side (upper side in FIG. 11) of the counter-rotating axial fan 1B, the boundary between the first inclined surfaces 2312B and the first joining surface 232B covers the boundary between the second inclined surface 3312B and the second joining surface 332B. In addition, an angle of a tangent line of each first inclined surface 2312B with respect to the center axis J1 at the boundary with the first joining surface 232B is substantially the same as that of each second inclined surface 3312B at the boundary with the second joining surface 332B.

Since the first inclined surfaces 2312B are provided, the space defined in the first housing member 23B expands in a portion adjacent to the first joining surface 232B in which the first inclined surfaces 2312B are arranged. Hereinafter, the portion of the first housing member 23B is referred as a first expanding portion. Similarly, the second housing member 33B expands in a portion adjacent to the second joining surface 332B in which the second inclined surfaces 3312B are arranged. The portion of the second housing member 33B is hereinafter referred to as a second expanding portion. The first and second expanding portions form together a single expanding portion of the housing of the counter-rotating axial fan 1B, as shown in FIG. 10. The details of the expanding portion are described referring to FIGS. 11 and 14.

The first expanding portion formed by the first inclined surfaces 2312B are formed to gradually increase an area of a cross section of an air path substantially perpendicular to the center axis J1 as the first expanding portion moves toward the first joining surface 232B. The cross-sectional area of the air path is the largest at the first joining surface 232B. Similarly, the second expanding portion formed by the second inclined surfaces 3312B are formed to gradually increase the cross-sectional area of the air path as the second expanding portion moves toward the second joining surface 332B. The cross-sectional area of the air path is the largest at the second joining surface 332B. As described above, the expanding portion of each housing member 23B or 33B is formed by the inclined surfaces 2312B or 3312B in each of which the cross-sectional area of the air path increases as the housing member moves toward its joining surface.

In other words, in this arrangement, the area of the cross section of the air path substantially perpendicular to the center axis J1 is larger in the expanding portion (in the first and second expanding portions) than that of the air path surrounded by the first and second surrounding portions 2311B and 3311B. Therefore, the cross-sectional area of the air path is larger than in the expanding portion than in the axially middle portions of the first and second housing members 23B and 33B.

With this arrangement, each of the first housing member 23B and the second housing member 33B can be formed from resin by injection molding by using only two mold pieces, e.g., upper and lower molds, which can be separated from each other in the axial direction of the housing member.

That is, it is possible to mold the first housing member 23B and the second housing member 33B without undercut molding. This is advantageous in reduction in the cost required for manufacturing mold pieces and improvement of the quality of the product to be molded.

When an air flow is generated by rotation of the first impeller 21, a centrifugal force acts on the air flow. Thus, the air flow contains a radially outward velocity component directed outward in the radial direction. Since the first expanding portion of the first housing member 23B and the second expanding portion of the second housing member 33B are joined to each other to form a single expanding portion as described above, the air flow can flow outward in the radial direction easily and more smoothly. Thus, the power consumption of the first motor 22 for rotating the first impeller 21 can be reduced. Moreover, air flowing along the first inclined surfaces 2312B of the first expanding portion is guided by the second inclined surfaces 3312B of the second expanding portion toward the second impeller 31. Thus, a created turbulent air flow is small. Accordingly, air can be efficiently discharged by the second impeller 31 from the second housing member 33B.

Improvement of characteristics of the counter-rotating axial fan 1B is now described, as compared with a counter-rotating axial fan in which no expanding portion is formed (hereinafter, referred to as a counter-rotating axial fan of Comparative Example).

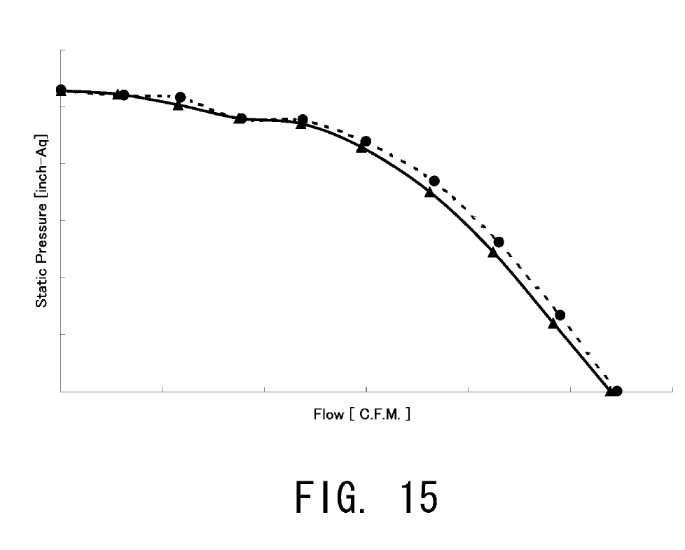

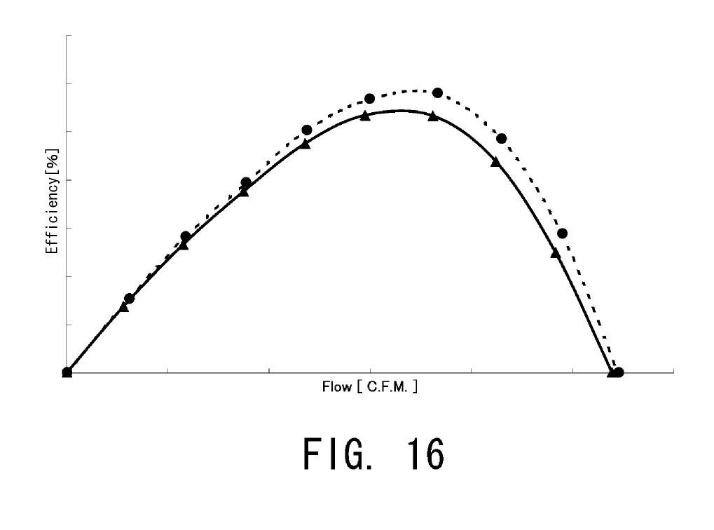

FIG. 15 shows static pressures measured for the counter-rotating axial fan 1B of the fourth preferred embodiment and the counter-rotating axial fan of Comparative Example. In FIG. 15, values of the measured static pressure (inch-Aq) are plotted against the air flow (CFM) represented by the horizontal axis. FIG. 16 shows efficiencies of the counter-rotating axial fan 1B of the fourth preferred embodiment and the counter-rotating axial fan of Comparative Example. In FIG. 16, measured values representing the efficiency (%) are plotted against the air flow (CFM). Please note that the efficiency means static pressure efficiency.

As shown in FIGS. 15 and 16, both the static pressure and the efficiency of the counter-rotating axial fan 1B of the fourth preferred embodiment were the same as or higher than those of the counter-rotating axial fan of Comparative Example in an approximately entire range of the air flow. The graphs of FIGS. 15 and 16 show that the first and second axial fans 2b and 3B operate efficiently because a turbulent air flow becomes small. Also, it is shown from the graphs that the static pressure characteristics are not degraded.

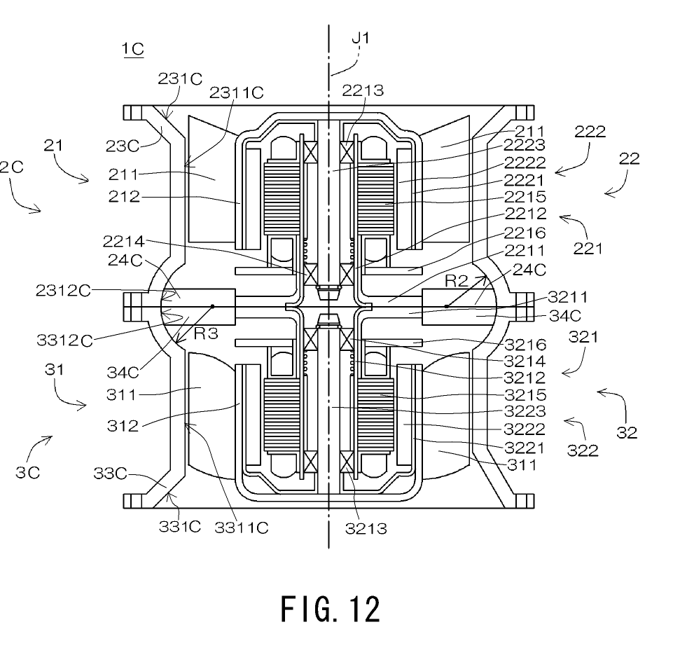

Next, an exemplary variant of the counter-rotating axial fan 1B of the fourth preferred embodiment is described, referring to FIG. 12. FIG. 12 is a cross-sectional view of an exemplary variant of the counter-rotating axial fan 1C, cut along the same plane as that in FIG. 11, i.e., a plane containing the center axis J1 and a diagonal line of two opposite corners of the four-sided housing when viewed from the upper side in FIG. 12.

The variant shown in FIG. 12 preferably has the same structure as the counter-rotating axial fan 1B of the fourth preferred embodiment, except for the first expanding portion and the second expanding portion. In this variant, the first expanding portion is formed by a first curved surface 2312C and the second expanding portion is formed by a second curved surface 3312C. The first curved surface 2312C has a substantially constant radius of curvature R2 and the second curved surface 3312C has a substantially constant radius of curvature R3. Moreover, the radii of curvature R2 and R3 preferably are substantially the same as each other. The first curved surface 2312C and the second curved surface 3312C are designed and arranged such that the center of the radius of curvature R2 is the same as that of R3.

With this configuration, it is possible to reduce a turbulent air flow passing by the expanding portion formed by the first and second expanding portions in this variant. Although the radii of curvature R2 and R3 of the first and second curved surfaces 2312C and 3312C preferably are substantially the same, they may be different. Even if the radii of curvature R2 and R3 are different, the turbulent air flow can be reduced in the counter-rotating axial fan 1C of this variant.

It should be noted that the expanding portion described in any of the third and fourth preferred embodiments and the variant of the fourth preferred embodiment may be provided in the counter-rotating fans of the first and second preferred embodiments, as shown in FIG. 3, for example. In this case, the effects described in the third and fourth preferred embodiments can be also obtained in the counter-rotating fans of the first and second preferred embodiments.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A counter-rotating axial fan comprising:
a first impeller centered on and rotatable about a center axis, the first impeller having a plurality of first blades which are arranged about the center axis and extend outwardly in a radial direction perpendicular to or substantially perpendicular to the center axis;
a first motor arranged to rotate the first impeller;
a second impeller centered on and rotatable about the center axis and arranged axially adjacent to the first impeller, the second impeller having a plurality of second blades which are arranged about the center axis and extend outwardly in the radial direction;
a second motor arranged to rotate the second impeller in a direction opposite to a direction of rotation of the first impeller; and
a housing surrounding the first impeller and the second impeller to define an air path therein; wherein
the housing includes an expanding portion, an area of a cross section of the air path substantially perpendicular to the center axis being larger in the expanding portion than at least in a substantially axially middle portion thereof, the expanding portion being located between the first impeller and the second impeller.

2. The counter-rotating axial fan according to claim 1, wherein the housing includes a first housing member surrounding the first impeller and a second housing member surrounding the second impeller, and the first housing member and the second housing member are joined to each other to define the housing in the expanding portion.

3. The counter-rotating axial fan according to claim 2, wherein an end of the first housing member which is adjacent to the second housing member covers an end of the second housing member which is adjacent to the first housing portion, when the first housing member and the second housing member are viewed from above the first housing member.

4. The counter-rotating axial fan according to claim 3, wherein, at a connection of the housing where the first and second housing portions are joined to each other, an angle of a tangent line of an inner side surface of one of the first and second housing members with respect to the center axis is substantially equal to that of the other.

5. The counter-rotating axial fan according to claim 2, wherein the first and second housing members are approximately rectangular when viewed along the center axis, the first housing member includes at four corners four first inclined surfaces which are inclined with respect to the center axis so as to move away from the center axis as they move toward the second housing member, and the second housing member includes at four corners four second inclined surfaces which are inclined with respect to the center axis so as to move away from the center axis as they move toward the first housing member, and the first inclined surfaces and the second inclined surfaces together define the expanding portion of the housing.

6. The counter-rotating axial fan according to claim 2, further comprising:
a plurality of first ribs arranged about the center axis between the first impeller and the second impeller, extending from the first motor outwardly in the radial direction, and connected to the first housing member to support the first motor; and
a plurality of second ribs arranged about the center axis between the first impeller and the second impeller, extending from the second motor outwardly in the radial direction, and connected to the second housing member to support the second motor.

7. The counter-rotating axial fan according to claim 2, further comprising:
a plurality of first ribs arranged about the center axis between the first impeller and the second impeller, extending from the first motor outwardly in the radial direction, and connected to the first housing member to support the first motor; and
a plurality of second ribs arranged about the center axis on a side of the second impeller opposite to the first impeller, extending from the second motor outwardly in the radial direction, and connected to the second housing portion to support the second motor.
